(19) United States
(12) Patent Application Publication
(10) Pub. No.: US 2005/0125690 A1
(43) Pub. Date: Jun. 9, 2005

(54) METHOD FOR CONTROLLING AN INSTRUCTION MEMORY OF AN EMBEDDED SYSTEM

(76) Inventor: Wen-Long Chin, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,364

(22) Filed: Dec. 9, 2003

(51) Int. Cl. H04L 9/00

(52) U.S. Cl. 713/201

(57) ABSTRACT

A method for controlling an instruction memory (IM) of an embedded system. The embedded system is electrically connected to a memory device used for storing a plurality of program code segments. The embedded system includes the IM and an execution unit. The steps of the method are setting up a look-up table for recording the operation status of the IM, and determining if a specific program code segment of the program code segments has been stored in the IM or not according to the look-up table when the execution unit selects the specific program code segment to execute. If the specific program code segment has been stored in the IM, the execution unit reads the specific program code segment from the IM. If not, the execution unit loads the specific program code segment from the memory device and executes it.

### BACKGROUND OF INVENTION

1. Field of the Invention

The invention relates to a method for controlling an instruction memory (IM) of an embedded system, and more particularly, to a method for controlling the instruction memory of an embedded system applying to encryption/decryption.

2. Description of the Prior Art

An embedded system, originally defined by the institution of electrical engineers (IEE), is an application combining software and hardware. Since personal computer (PC) technology has developed by leaps and bounds, mobile phones, information appliances (IAs), and personal digital assistants (PDAs) have become very common applications of embedded systems. In contrast to a PC, an embedded system has a specific use and function, and its hardware is specifically designed according to the function requirements. On the other hand, the improvement of the semi-conductor fabrication results in that microprocessors, memories, and related electrical devices can be fabricated on a single chip, which is called system on chip (SOC). The SOC has an advantage of low cost and high efficiency, and therefore many embedded systems are designed by using SOCs. An embedded system often comprises a microprocessor and an instruction memory for storing data and programs it may execute. The embedded system reads programs from the instruction memory to execute for performing a specific function. During operation, the embedded system loads every program code that the embedded system may execute from an external memory device to the instruction memory, and then the embedded system reads required program codes from the instruction memory to execute. However, regardless of when and how many times the program codes will be executed, the prior-art embedded system loads all the program codes that it may execute into the instruction memory. As a result, the instruction memory of the embedded system has to have a very large space for storing these program codes. When the required space of the instruction memory becomes larger, the die size of the SOC of the embedded system also becomes larger, and this results in lower fabrication yields and higher cost.

### SUMMARY OF INVENTION

It is therefore a primary objective of the claimed invention to provide a method for controlling an instruction memory of an embedded system, wherein a look-up table is used to control the access of the instruction memory to solve the above-mentioned problem.

According to the claimed invention, the method for controlling the instruction memory of the embedded system is provided. The embedded system is electrically connected to a memory device for storing a plurality of program code segments. The embedded system comprises the instruction memory for receiving and registering the program code segments stored in the memory device and an execution unit for executing the program code segments. The method comprises the following steps: (a) setting up a look-up table for recording the operation status of the instruction memory; (b) selecting a specific program code segment from the program code segments to execute with the execution unit;(c) determining if the specific program code segment has been stored in the instruction memory according to the look-up table before performing step (b); (d) reading the specific program code segment from the instruction memory to execute with the execution unit if the result of step (c) is true; and (e) loading the specific program code segment from the memory device to execute with the execution unit if the result of step (c) is false.

It is an advantage of the claimed invention that the method for controlling the instruction memory of the embedded system only keeps the required program code segments in the instruction memory, so that the space of the instruction memory of the embedded system can be substantially reduced. Therefore the cost of the embedded system can be decreased and the embedded system can still have improved performance.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of an embedded system set in a home gateway according to the present invention.

FIG. 2 is a flowchart of the method for controlling the embedded system shown in FIG. 1.

FIG. 3 is a schematic diagram of the look-up table shown in FIG. 1.

### DETAILED DESCRIPTION

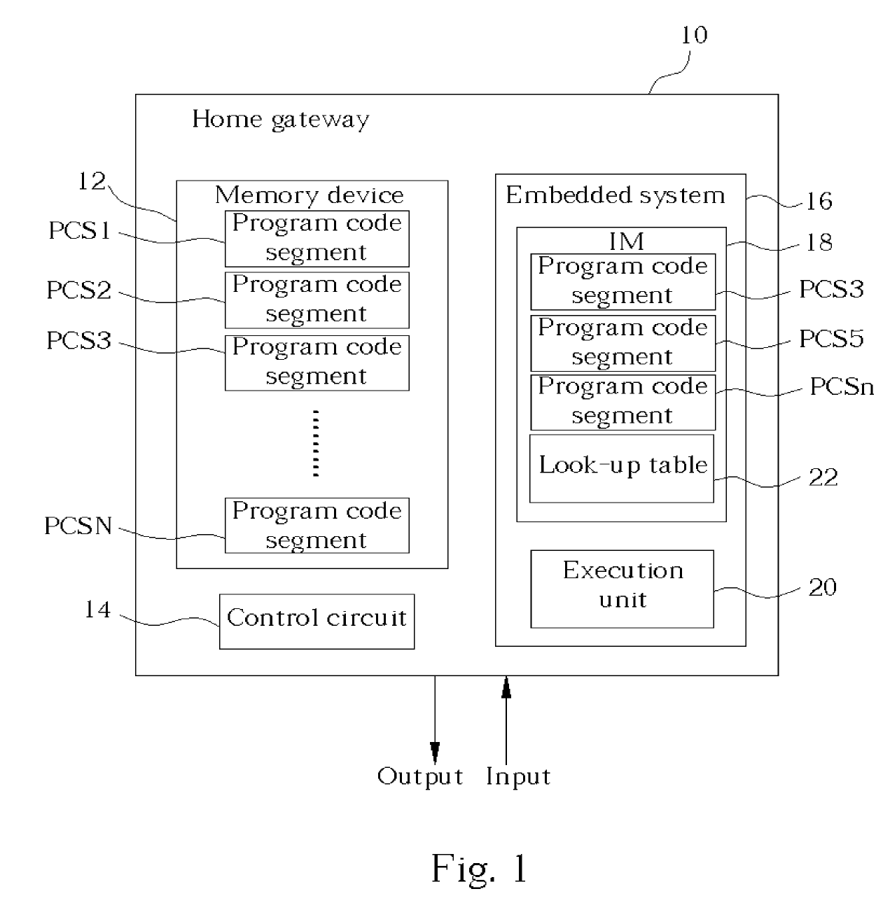

FIG. 1 is a function block diagram of an embedded system 16 set in a home gateway 10 according to the present invention. In this embodiment, the present invention method applies to the home gateway 10. The home gateway 10 is used for Internet encryption or decryption, especially for installing a virtual private network (VPN). The home gateway 10 comprises a memory device 12, a control circuit 14, an embedded system 16 serving as a microprocessor, and Internet interface software and hardware (not shown). The memory device 12 is electrically connected to the embedded system 16 and contains a plurality of program code segments PCS1-PCSN stored therein, wherein each of the program code segments PCS1-PCSN comprises a plurality of instructions. The embedded system 16 comprises an instruction memory 18 and an execution unit 20. The instruction memory 18 is used for receiving and registering the program code segments stored in the memory device 12. The execution unit 20 is used for executing the program code segments registered in the instruction memory 18. In addition, the execution unit 20 can be an application specific integrated circuit (ASIC) or other logic execution unit having the similar functionality, wherein the ASIC is a device that performs some specific logic calculations for some specific purposes. Therefore, in contrast to the integration circuit with no specific purpose, the execution unit 20 only comprises a simple hardware design.

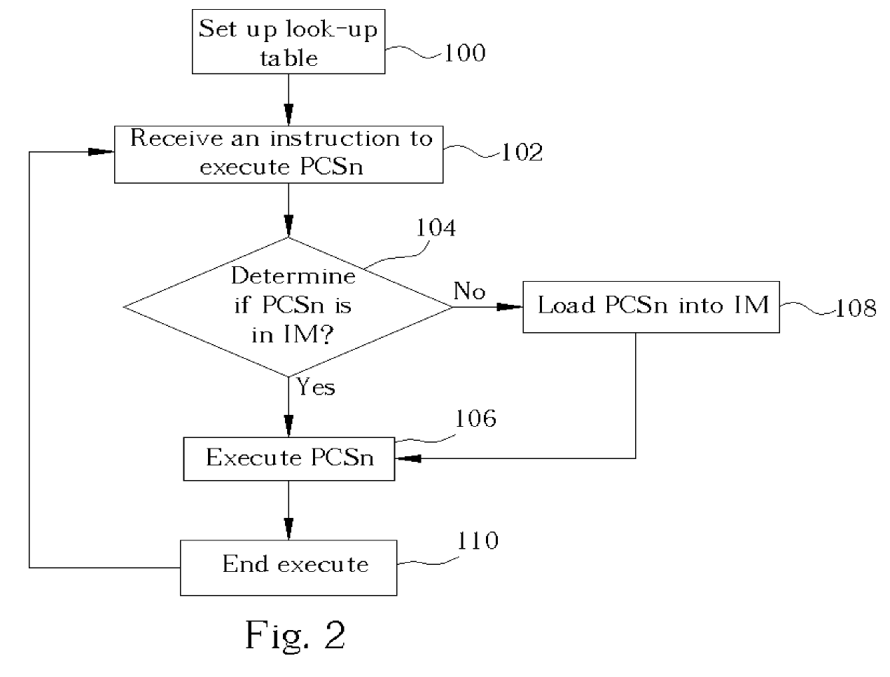

FIG. 2 is a flowchart of the method for controlling the embedded system 16 shown in FIG. 1 according to the present invention. The embedded system 16 applies to the home gateway 10. The present invention method comprises the following steps:

Step 100: Set up a look-up table 22 in the instruction memory 18 of the embedded system 16 for recording the operation status of the instruction memory 18.

Step 102: The embedded system 16 receives an instruction from the home gateway 10 to execute a specific program code segment PCSn, wherein the specific program code segment PCSn is selected from the program code segments PCS1-PCSN stored in the memory device 12.

Step 104: Determine if the program code segment PCSn has been stored in the instruction memory 18 according to the look-up table 22. If it has, go to step 106; if not, go to step 108.

Step 106: The execution unit 20 loads the program code segment PCSn from the instruction memory 18 and executes the program code segment PCSn. Go to step 110.

Step 108: Read the program code segment PCSn from the memory device 12 and load the program code segment PCSn into the instruction memory 18; meanwhile, refresh the record of the look-up table 22 to record that the program code segment PCSn is stored in the instruction memory 18.

Step 110: End the execution of the program code segment PCSn. After that, if the home gateway 10 sends another instruction to the embedded system 16 to execute other program code segments, go to step 102.

Before performing step 108, the embedded system 16 checks if the instruction memory 18 has enough space for storing the program code segment PCSn. If the result is true, then step 108 is performed to store the program code segment PCSn into the instruction memory 18 and execute it. If the instruction memory 18 does not have enough space for storing the program code segment PCSn, a memory space of the instruction memory 18 is overlapped with the program code segment PCSn. For example, the program code segment PCSn may be swapped into the memory space of the instruction memory 18 originally containing the program code segments PCS3 or PCS5. In this embodiment, step 100 to step 110 are controlled by the control circuit 14.This means a host, i.e. the home gateway 10, comprising the embedded system 16 controls the access of the instruction memory 18 and determines whether or not the program code segment PCSn going to be executed has been stored in the instruction memory 18. If the program code segment PCSn is not in the instruction memory 18, the host will ask the execution unit 20 to load the program code segment PCSn from the memory device 12 into the instruction memory 18 and execute the program code segment PCSn. In another embodiment of the present invention, the performance of step 100 to step 110 can be totally controlled by the execution unit 20. Under this situation, the execution unit 20 can determine whether or not the program code segment PCSn is already in the instruction memory 18, load the program code segment PCSn, and directly access the memory device 12by itself, without further instructions from the host.

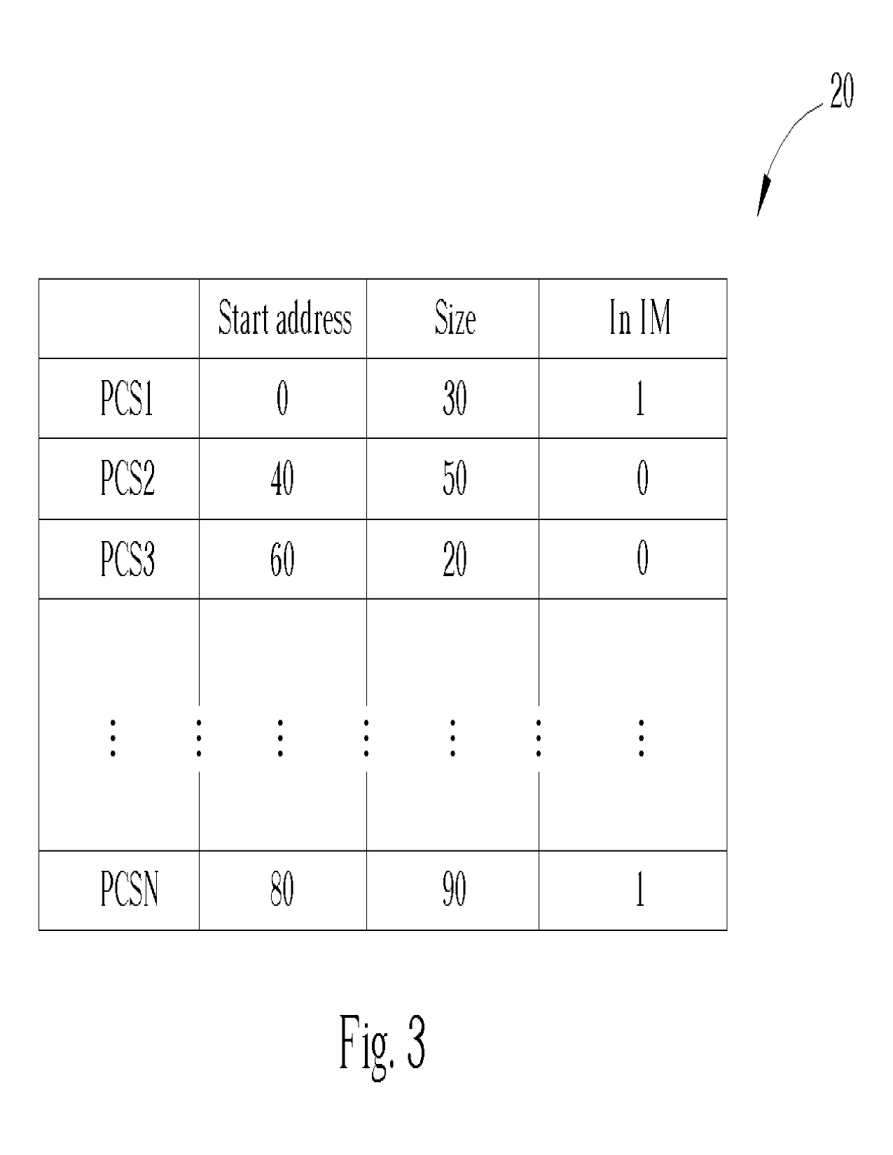

FIG. 3 is a schematic diagram of the look-up table 22 shown in FIG. 1. The look-up table 22 is a one-to-one mapping look-up table of the program code segments PCS1-PCSN. Each of the rows records the status of a corresponding program code segment PCSx in the instruction memory 18. The name of each of the program code segments PCS1-PCSN is listed in the first column, and the second column shows the start addresses of each of the program code segments PCS1-PCSN. The third column shows the size of the program code segments PCS1-PCSN, and the fourth column indicates whether the program code segments PCS1-PCSN have been stored in the instruction memory 18 individually. If the value in the fourth column is “1”, the program code segment PCSx listed in the same row has been loaded in the instruction memory 18. On the contrary, if the value of the fourth column is “0”, the program code segment PCSx is not in the instruction memory 18. Therefore, in step 108, to refresh the look-up table 22 is to find the name in the first column to get a corresponding record and refresh the value as “1” in the fourth column so as to indicate that the program code segment PCSn is stored in the instruction memory 18. Furthermore, when the remaining space of the instruction memory 18 is not enough and the program code segment PCSn is loaded to overlap a program code segments PCSx originally stored in the instruction memory 18, the records of both the program code segment PCSn and PCSx in the look-up table 20 will be refreshed. As described above, the look-up table 22 is set up in the instruction memory 18 in this embodiment; however, the look-up table 22 is not limited from being set up in other memory devices. For example, the look-up table 22 can be set up in the memory device 12.

In addition, the present invention can apply to any systems related to modular algorithms, especially to systems used for performing many small modular algorithms. The practice is described as below. The modular algorithms are pre-stored in a ROM or DRAM. When the system needs to execute a first modular algorithm, it loads the first modular algorithm into the instruction memory. Then, when the system needs to execute the next modular algorithm, it loads the next modular algorithm to swap the first modular algorithm in the instruction memory. As a result, a modular system can be implemented with fewer hardware resources for multiple functions.

In contrast to the prior art that copies all programs or algorithms into the instruction memory, the present invention method selectively loads some specific program code segments into the instruction memory and only reserves the program code segments needed in the instruction memory. Accordingly, the space of the instruction memory can be effectively reduced so as to reduce the cost and improve system performance, and further, to raise the yield of the system.

Those skilled in the art will readily observe that numerous modifications and alterations of the device may be made while retaining the teachings of the invention. Accordingly, the above disclosure should be construed as limited only by the metes and bounds of the appended claims.

1. A method for controlling an instruction memory (IM) of an embedded system, wherein the embedded system is electrically connected to a memory device used for storing a plurality of program code segments, and the embedded system comprises:
the instruction memory for receiving and registering the program code segments stored in the memory device;
and
an execution unit for executing the program code segments; the method comprising the following steps:
(a) setting up a look-up table for recording an operation status of the instruction memory;
(b)selecting a specific program code segment from the program code segments and executing the specific program code segment with the execution unit;
(c) determining if the specific program code segment has been stored in the instruction memory according to the look-up table before performing step (b);
(d)reading the specific program code segment from the instruction memory to execute with the execution unit if the result of step (c) is true; and
(e)loading the specific program code segment from the memory device to execute with the execution unit if the result of step (c) is false.

2. The method of claim 1, wherein step (e) further comprises the following step:
(f)storing the specific program code segment into the instruction memory and refreshing a record of the look-up table for recording that the specific program code segment has been stored in the instruction memory.

3. The method of claim 2, wherein step (e) further comprises the following steps:
(g)checking if the instruction memory has enough space for storing the specific program code segment before performing step (f) to store the specific program code segment into the instruction memory;
(h)storing the specific program code segment into the instruction memory if the result of step (g) is true; and
(i)overlapping the instruction memory with the specific program code segment if the result of step (g) is false.

4. The method of claim 3, wherein step (i) further comprises the following step:
(j)refreshing the look-up table to record that the specific program code segment has been stored into the instruction memory and another program code segment originally stored in the instruction memory has been erased.

5. The method of claim 1, wherein execution of steps (a) to (e) is controlled by the execution unit.

6. The method of claim 1, wherein the embedded system is electrically connected to a host, the host comprising a control circuit for controlling the execution of steps (a) to (e).

7. The method of claim 1, wherein each of the program code segments comprises a plurality of instructions.

8. The method of claim 1, wherein the execution unit is an application specific integrated circuit (ASIC).

9. The method of claim 1, wherein the embedded system is used for encryption or decryption.

10. The method of claim 1, wherein the look-up table is set up in the memory device.

11. The method of claim 1, wherein the look-up table is set up in the instruction memory.
